(19) United States
(12) Patent Application Publication
(10) Pub. No.: US 2023/0004426 A1
(43) Pub. Date: Jan. 5, 2023

(54) Distributed Processing System

(71) Applicant: Nippon Telegraph and Telephone Corporation, Tokyo (JP)

(72) Inventors: Tsuyoshi Ito, Tokyo (JP); Kenji Tanaka, Tokyo (JP); Yuki Arikawa, Tokyo (JP); Kazuhiko Terada, Tokyo (JP); Takeshi Sakamoto, Tokyo (JP)

(21) Appl. No.: 17/781,337

(22) PCT Filed: Dec. 5, 2019
(86) PCT No.: PCT/JP2019/047631

§ 371 Date: May 31, 2022

(51) Int. Cl. G06F 9/48

(52) U.S. Cl. CPC G06F 9/4875

(57) ABSTRACT

A distributed processing system including a plurality of distributed systems, transmission media connecting the plurality of distributed systems and a control node connected to the plurality of distributed systems, wherein each of the distributed systems includes one or more distributed nodes constituting a distributed node group and a piece of electric equipment accommodating the distributed node group. Each of the distributed nodes includes interconnects to connect to any of the transmission media and/or other distributed nodes; and the control node determines, based on a quantity of computational resources required for a job, distributed systems, distributed systems and distributed nodes in the distributed systems to execute the job from the plurality of distributed systems, selects a connection path for data to be processed among the distributed systems, and provides information about an interconnect connection path for the distributed nodes to execute the job.

### CROSS-REFERENCE TO RELATED APPLICATIONS

This application is a national phase entry of PCT Application No. PCT/JP2019/047631, filed on Dec. 5, 2019, which application is hereby incorporated herein by reference.

### TECHNICAL FIELD

The present invention relates to a distributed processing system that causes a plurality of distributed systems to cooperate with one another to perform information processing.

### BACKGROUND

In deep learning, inference accuracy is improved by updating, for a learning target constituted by multi-layered neuron models, a weight for each neuron model (a coefficient by which a value output by a neuron model at a previous stage is to be multiplied) based on input sample data.

In general, a mini batch method is used as a method for improving inference accuracy. In the mini batch method, a gradient computation process for computing a gradient relative to the weight for each piece of sample data, an aggregation process for aggregating gradients for a plurality of different pieces of sample data (adding up the gradients obtained for piece of sample data, by weight) and a weight update process for updating each weight based on the aggregated gradient are repeated.

These processes, especially the gradient computation process requires many computations, and, there is a problem that, when the number of weights and the number of pieces of sample data to be input increase in order to improve inference accuracy, time required for the deep learning increases.

A distributed processing method is used to speed up the gradient computation process. Specifically, a plurality of distributed nodes are provided, and each of the nodes performs the gradient computation process for different sample data. Thereby, it becomes possible to increase the number of pieces of sample data that can be processed in a unit time in proportion to the number of distributed nodes, and, therefore, the gradient computation process can be speeded up (see, for example, Non-Patent Literature 1).

Recently, deep learning has been applied to more complicated problems, and the total number of weights and the number of pieces of sample data tend to increase. Therefore, time required until a deep learning process is completed increases, and it is necessary to increase the number of distributed nodes to respond thereto (see, for example, Non-Patent Literature 2).

When the number of distributed nodes increases, however, power required for the distributed nodes and a load on a system for cooling the distributed nodes increase in proportion to the number. Thereby, a capacity of electric equipment required to accommodate them becomes enormous (see, for example, Non-Patent Literature 3). Further, when the distributed nodes are collected in one building, there is a technical problem such as redundancy of large-capacity electrical equipment for the purpose of improvement of reliability. There are also problems that distributed processing stops due to a failure by a disaster and that early recovery at the time of a disaster is difficult, because the distributed processing system is concentrated in the one building.

As a method for solving the above problems, there is a method of installing a plurality of distributed nodes 603 within a range of the power capacity of electric equipment to configure each of distribution systems 601, and connecting the distributed systems 601 via aggregation switches 602 as shown in FIG. 7. However, there is a problem that, when the connection scale increases, the number of stages of the aggregation switches 602 increases, delays are accumulated, and processing performance decreases. Therefore, a flexible system has come to be required which does not require a large number of distributed nodes and pieces of electric equipment to respond to the peak of the amount of information processing in one building and which is capable of responding to a necessary amount of information processing even if the system scale required for information processing increases to some extent.

### CITATION LIST

### Non-Patent Literature

Non-Patent Literature 1: Takuya Akiba, Shuji Suzuki, Keisuke Fukuda, “Extremely Large Minibatch SGD: Training ResNet-50 on ImageNet in 15 Minutes”, Cornell University Library, U.S.A., arXiv:1711.04325,2017, Internet <https://arxiv.org/abs/1711.04325>

Non-Patent Literature 2: Hiroyuki Miyazaki et.al, “Overview of the K computer System”,FujitsuSci. Tech. J., Vol. 48, No. 3, pp. 255-265 (July 2012)

Non-Patent Literature 3: Yoshihiro Sekiguchi et.al, “Construction and Facilities Technologies for the K computer”, FujitsuSci. Tech. J., Vol. 48, No. 3, ^{pp.} 266-273 (July 2012).

### SUMMARY

### Technical Problem

Embodiments of the present invention have been made in view of the situation as described above, and an object thereof is to provide a distributed processing system capable of controlling power required for one building where a distributed node group is installed as well as flexibly and efficiently setting the scale of distributed systems without performing multi-stage connection of aggregation switches that may cause accumulation of delays, and performing highly reliable and high-speed information processing.

### Means for Solving the Problem

In order to solve the above problem, a distributed processing system of embodiments of the present invention is a distributed processing system including a plurality of distributed systems, transmission media connecting the plurality of distributed systems and a control node connected to the plurality of distributed systems, wherein each of the distributed systems includes one or more distributed nodes constituting a distributed node group and a piece of electric equipment accommodating the distributed node group; each of the distributed nodes includes interconnects to connect to any of the transmission media and/or other distributed nodes; and the control node determines, based on a quantity of computational resources required for a job to be executed in the distributed processing system, distributed systems and distributed nodes in the distributed systems to execute the job from among the plurality of distributed systems, selects a connection path for data to be processed among the distributed systems, and provides information about an interconnect connection path for the distributed nodes of the distributed systems to execute the job.

### Effects of embodiments of the Invention

In embodiments of the present invention, by, according to the quantity of computational resources to be processed by a distributed processing system, configuring a large distributed system by connecting distributed systems each of which is composed of a distributed node group composed of a plurality of distributed nodes and electric equipment accommodating the distributed node group, it is possible to provide a distributed processing system capable of controlling power required for one building where a distributed node group is installed as well as flexibly and efficiently setting the scale of the distributed processing system, and performing highly reliable and high-speed information processing.

### BRIEF DESCRIPTION OF THE DRAWINGS

FIG. 1 is a diagram showing a configuration example of a distributed processing system according to a first embodiment of the present invention.

FIG. 2 shows a configuration example of a distributed node in a distributed system of the embodiment of the present invention.

FIG. 3 is a diagram showing a configuration example of a control node in the distributed processing system according to the embodiment of the present invention.

FIG. 4 is a diagram showing a configuration example of a computer constituting the control node according to the embodiment of the present invention.

FIG. 5 is a diagram showing a configuration example of a distributed processing system according to a second embodiment of the present invention.

FIG. 6 is a diagram for illustrating an operation of the distributed processing system according to the second embodiment of the present invention.

FIG. 7 is a diagram showing a conventional distributed processing system.

### DETAILED DESCRIPTION OF ILLUSTRATIVE EMBODIMENTS

Embodiments of the present invention will be explained below with reference to drawings. In the explanation below, “nodes” refers to pieces of equipment such as servers that are distributedly arranged on a network.

### First Embodiment

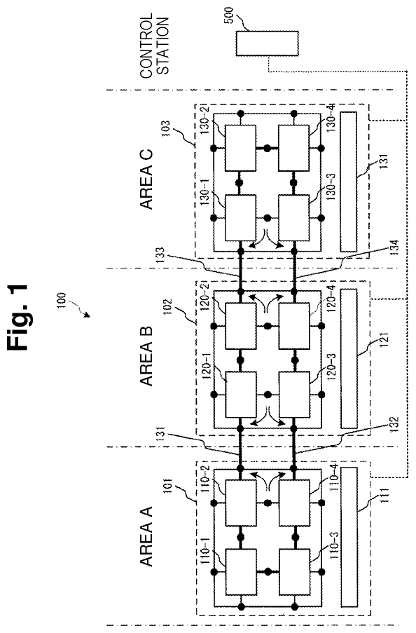

FIG. 1 is a diagram showing a configuration example of a distributed processing system according to a first embodiment of the present invention. The distributed processing system in FIG. 1 is composed of distributed systems 101 to 103. The distributed systems 101, 102 and 103 are installed in areas A, B and C, respectively. In the distributed systems, pieces of electric equipment 111, 121 and 131 each of which accommodates a plurality of distributed nodes are installed, respectively. Further, in a control station, a control node 500 connected to each of the distributed systems is installed.

### Configuration of Distributed Processing System

In the configuration example of FIG. 1, each of the distributed systems 101 to 103 is composed of four distributed nodes. The distributed system 101 is composed of distributed nodes 110-1 to 110-4; the distributed system 102 is composed of distributed nodes 120-1 to 120-4; and the distributed system 103 is composed of distributed nodes 130-1 to 130-4. Furthermore, each of the distributed nodes is provided with four interconnects, and, in each of the distributed systems, distributed nodes are connected in a ring shape, with two interconnects being used between two nodes.

In FIG. 1, two transmission media such as optical fibers usable for distributed systems are laid between the areas A and B and between the areas B and C. Between the areas A and B, the distributed systems 101 and 102 are connected via transmission media 131 and 132. Between the areas B and C, the distributed systems 102 and 103 are connected via transmission media 133 and 134.

The control node 500 is connected to the distributed systems 101 to 103 of the areas A, B and C and can control the distributed system of each area. The control node 500 has a function of accepting a job from a user and a function of controlling the distributed processing system according to the content of the job. In the configuration example of FIG. 1, the control node 500 is installed in the control station at a place different from the places of the distributed systems of the areas A to C. The control node 500, however, is not necessarily required to be installed in the control station at a place different from the places of the distributed systems but may be installed at the same place as the distributed system of the area A, B or C or in the distributed system or may be installed as a part of a distributed node.

### Configuration of Distributed Node

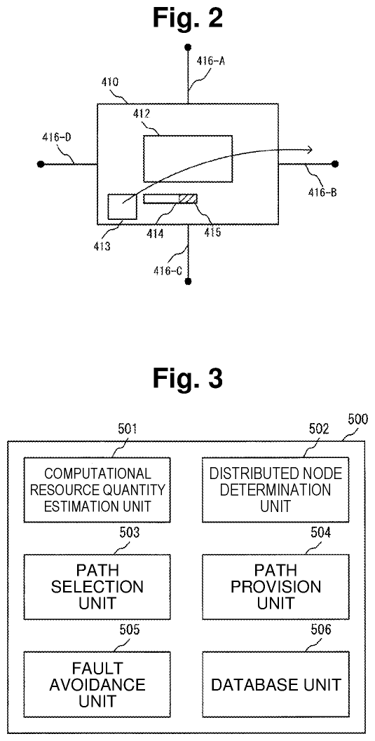

FIG. 2 shows a configuration example of a distributed node in a distributed system of the present embodiment. A distributed node 410 is provided with interconnects 416A to 416D, a path selection circuit 412, an arithmetic device 413 to perform processing of data. The path selection circuit 412 is connected to the arithmetic device 413 and the interconnects 416A to 416D of the four ports. The path selection circuit 412 transmits data processed by the arithmetic device 413 to at least any of the interconnects 416A to 416D that has been selected according to path information from the control node 500.

As the arithmetic device 413, a CPU (central processing unit), a GPU (graphics processing unit), an FPGA (field programmable gate array), a quantum arithmetic device, an artificial intelligence (neuron) chip or the like can be used.

Here, the number of distributed nodes constituting a distributed system is not limited to four but may be more than four if the electric equipment of each distributed system can accommodate the distributed nodes. As for the number of interconnects provided in each distributed node also, the number is not limited to four ports. The number of interconnects corresponding to the number of transmission media or the like that can be connected to other distributed systems can be provided.

### Configuration and Operation of Control Node

FIG. 3 shows a configuration example of a control node in the present embodiment. The control node 500 is provided with a computational resource quantity estimation unit 501, a distributed node determination unit 502, a path selection unit 503, a path setting unit 504, a fault avoidance unit 505 and a database unit 506. The control node 500 is connected to all areas including the areas A, B and C via a network and can control a distributed system installed in each area.

The control node 500 has a database that includes computational resource information including computational power of each distributed node to which the control node 500 is connected, arithmetic resource information including computational power of the arithmetic device of each distributed node, and a communication bandwidth between devices in each distributed node or between distributed nodes, position information about the distributed nodes and the like. The control node 500 searches for available computational resources using such a database and determines distributed nodes and a connection path required to process a job.

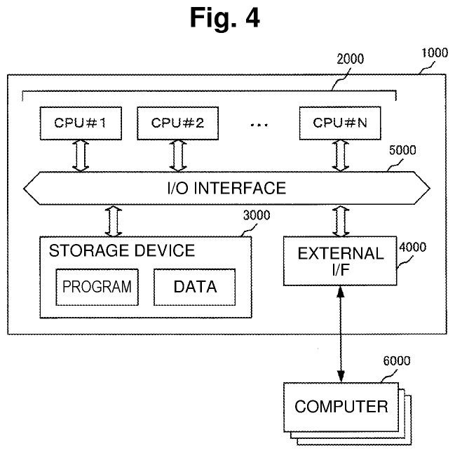

The control node 500 in the present embodiment can be realized by a computer provided with the computational resource quantity estimation unit 501, the distributed node determination unit 502, the path selection unit 503, the path setting unit 504, the fault avoidance unit 505, the database unit 506, a CPU (central processing unit), a storage device and an external interface (hereinafter referred to as an external I/F) and a program that controls these hardware resources as an example. A configuration example of such a computer is shown in FIG. 4.

A computer 1000 is provided with a CPU 2000, a storage device 3000 and an external I/F 4000, which are mutually connected via an I/O interface 5000. The program for realizing the operation of the control node of the present embodiment, computational resource information, arithmetic resource information including the computational power of the arithmetic device of each distributed node, and the like are stored in the storage device 3000. Computers that mutually transmit/receive signals are connected to the external I/F 4000. The CPU 2000 executes the process explained in the present embodiment according to the program and the like stored in the storage device 3000. Further, a configuration is also possible in which the processing program is recorded to a computer-readable recording medium.

### Device Configuration of Distributed Node

Next, a specific device configuration example of each distributed node will be explained. The specific device configuration of each distributed node explained below is an exemplification, and the device configuration is not limited thereto.

Each distributed node in the present embodiment is, for example, a SYS-4028GR-TR2 server made by Super Micro Computer, Inc. (hereinafter referred to as “the server”). Each of the interconnects of the distributed node is composed of an interconnect card and an interconnect port. For example, a VCU118 Evaluation board made by Xillinx Inc. (hereinafter referred to as “the FPGA board”) is inserted in the 16-lane slot of PCI Express 3.0 (Gen 3) of the server as an interconnect card. Furthermore, on the FMC+ port on the FPGA board, HTG-FMC-X2QSFP28 made by HiTech Global, LLC. (hereinafter referred to as “the daughter board”) is mounted.

Further, for each of two ports, two 100-Gbps QSFP28-type optical transceivers are prepared on each of the FPGA board and the daughter board as interconnect ports, four ports thus being prepared in total. Thus, each server constituting a distributed node can be provided with four interconnects.

The path selection circuit is written on an FPGA chip on the FPGA board as a circuit. The interconnects are not limited to optical transceivers, and PCIe's that are exclusively used as internal buses of a distributed node is also included. The explanation below will be made with the optical transceiver part of an interconnect as the interconnect.

### Operation of Distributed Node

### Step 0: Acceptance of Job and Estimation of Resources

Here, operations of the distributed nodes in the present embodiment will be explained using FIGS. 1 and 2. First, it is assumed that the four distributed nodes 110-1 to 110-4 of the distributed system 101 of the area A, which are connected in a ring configuration, are performing distributed processing for a certain computation job. A case is assumed where, when a new computation job is given after the computation job ends, the control node 500 determines that three times the quantity of computational resources is required to process the new computation job.

### Step 1: Grasping Of Operation Situation

The control node 500 secures operations of the distributed systems 101 to 103 of the areas A to C so that three times the quantity of computational resources can be obtained, based on the estimated quantity of computational resources. That is, this case is a case where it is determined that resources of twelve distributed nodes are required.

### Step 2: Grasping Of Connection Situation

Before the operation of the distributed systems 101 to 103 is secured at step 1, the distributed nodes 110-2 and no-4 of the area A are mutually connected via interconnects. The selection circuit of the distributed node 110-2 is in a state that a data path is set in a downward direction of the drawing, which is a direction toward the distributed node node 110-4. The selection circuit of the distributed node 100-4 is in a state that a data path is set in an upward direction of the drawing, which is a direction toward the distributed node 110-2.

The distributed nodes 120-1 and 120-3 of the area B are mutually connected via interconnects. The selection circuit of the distributed node 120-1 is in a state that a data path is set in the downward direction of the drawing, which is a direction toward the distributed node 120-3. The selection circuit of the distributed node 120-3 is in a state that a data path is set in the upward direction of the drawing, which is a direction toward the distributed node 120-1. Similarly, the distributed nodes 120-2 and 120-4 of the area B are mutually connected via interconnects. The selection circuit of the distributed node 120-2 is in a state that a data path is set in the downward direction of the drawing, which is a direction toward the distributed node 120-4. The selection circuit of the distributed node 120-4 is in a state that a data path is set in the upward direction of the drawing, which is a direction toward the distributed node 120-2.

Furthermore, the distributed nodes 130-1 and 130-3 of the area C are mutually connected via interconnects. The selection circuit of the distributed node 130-1 is in a state that a data path is set in the downward direction of the drawing, which is a direction toward the distributed node 130-3. The selection circuit of the distributed node 130-3 is in a state that a data path is set in the upward direction of the drawing, which is a direction toward the distributed node 130-1.

### Step 3: Switching of Path

In order to secure twelve distributed nodes in order to process the quantity of computational resources of the new computation job, the state is changed to a state in which the data path is set in the right direction of the drawing in the selection circuits of the distributed nodes 110-2 and 110-4 of the area A, based on connection path information provided from the control node ₅o. Further, in the state in which the distributed nodes 120-1 and 120-3 of the area B have been mutually connected via the interconnects, the downward data path is switched to a leftward data path in the selection circuit of the distributed node 120-1, and the upward data path is switched to a leftward data path in the selection circuit of the distributed node 120-3.

Similarly, in the state in which the distributed nodes 120-2 and 120-4 of the area B have been mutually connected via the interconnects, the downward data path is switched to a rightward data path in the selection circuit of the distributed node 120-2, and the upward data path is switched to a rightward data path in the selection circuit of the distributed node 120-4.

Furthermore, in the state in which the distributed nodes 130-1 and 130-3 of the area C have been mutually connected via the interconnects, the downward data path is switched to a leftward data path in the selection circuit of the distributed node 130-1, and the upward data path is switched to a leftward data path in the selection circuit of the distributed node 130-3.

By the series of data path switchings explained above, the distributed nodes constituting the distributed systems 101 to 103 of the areas A to C are connected in a ring shape. Due to the ring, the number has increased three times from four to twelve in comparison with the number of connected distributed nodes before the switchings, and it is possible to constitute a distributed processing system in which distributed systems installed in a plurality of areas are connected, to respond to the quantity of computational resources required to execute the new computation job. According to the present embodiment, it is possible to provide a distributed processing system capable of flexibly and efficiently setting the scale of the distributed processing system while controlling power required for one distributed system in which a distributed node group is installed, and performing highly reliable and high-speed information processing.

Each selection circuit for performing such a process can be realized by rewriting the FPGA chip mounted on the VCU118 Evaluation board made by Xillinx Inc., which has been described before. On the FPGA chip, a digital circuit can be freely rewritten within a range of resource restrictions. By performing bit rewriting on a register memory in the FPGA chip from outside to write a digital circuit capable of switching a path, on the FPGA chip, the selection circuit can be realized. Such a function is not limited to an FPGA chip. A general-purpose network card is also possible if the network card is provided with a plurality of ports, and the function can be realized by selecting an output port by a setting of a register memory.

Further, as another path switching method in a selection circuit, there is also a method in which a path factor is given to a header or the like of data of a distributed node. For example, it is possible to make a configuration in which, a circuit that, when data generated by the arithmetic device 413 in FIG. 2 is input to the path switching circuit 412, gives a path factor 415 like a port number to the beginning of the data is implemented in the selection circuit so that the data flows through a path corresponding to the path factor.

Specifically, in the distributed node 410, the interconnects 416A to 416D are associated with 2-bit path factors, 00, 01, 10 and 11, respectively. By giving a 2-bit path factor 415 to be a data path to the data output from the arithmetic node 413, the data from the arithmetic node can be output to an interconnect of a desired path by the selection circuit 412. Such path selection can be realized by a method in which a path factor is embedded in a reservoir part of an individual PCIe frame packet header, and the path factor is determined by the FPGA.

### Second Embodiment

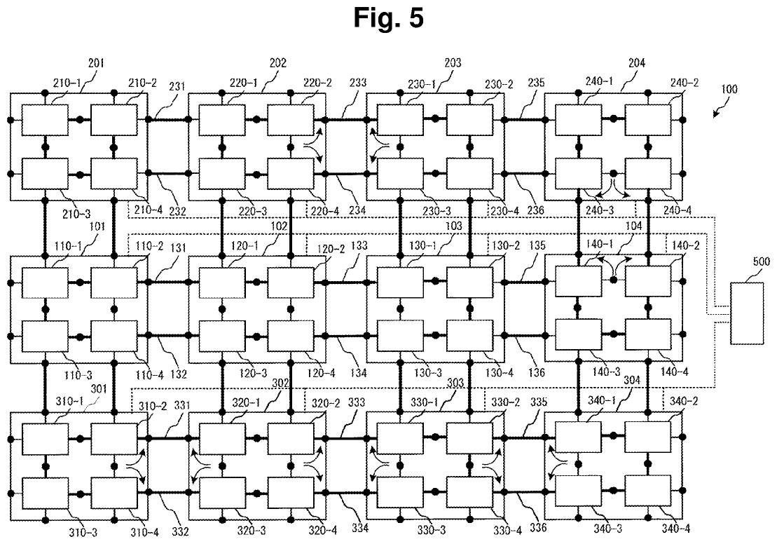

FIG. 5 is a diagram showing a configuration example of a distributed processing system according to a second embodiment of the present invention. FIG. 5 shows a configuration example in a case where embodiments of the present invention is applied to a wider-range distributed system group in comparison with FIG. 1. In addition to the areas A to C explained in FIG. 1, areas 1 to 4, areas (i) to (iv) and an area D are included. It is similar to FIG. 1 that a control node is arranged in a control station of the distributed processing system.

### Operation of Distributed Processing System

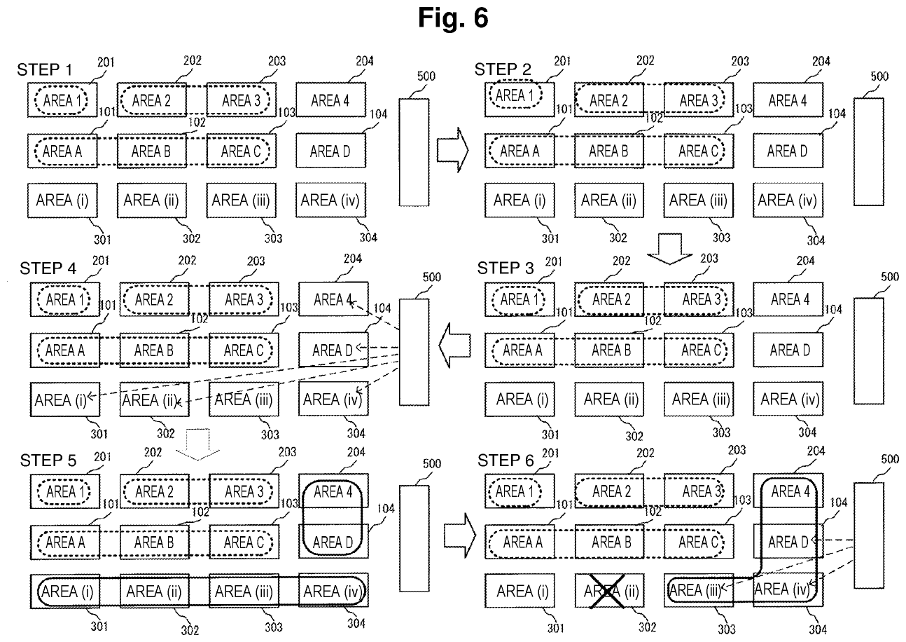

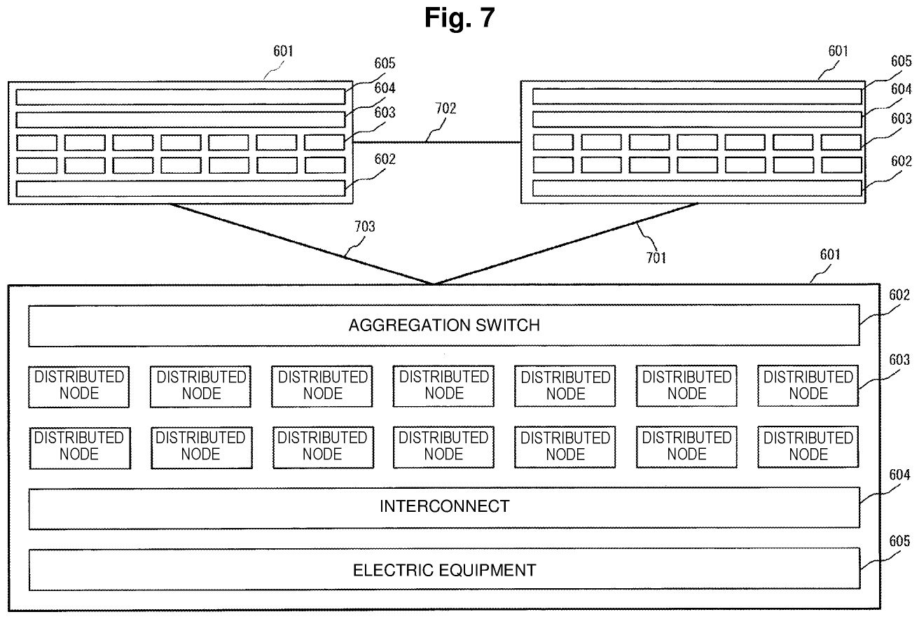

FIG. 6 is a diagram for illustrating an operation of the distributed processing system according to the second embodiment of the present invention. In FIG. 6, in addition to the operational situation of the computational resources for a job A by the twelve distributed nodes in the areas A to C, computational resources for a job B by four distributed nodes in the area 1 and computational resources for a job C by eight distributed nodes in the areas 2 and 3 are operating. That is, distributed processing of the job A is being performed in the areas A to C; distributed processing of the job B is being performed in the area 1; distributed processing of the job C is being performed in the areas 2 and 3. A case is assumed where, in the above state, a job requiring eight distributed nodes (a job D) as computational resources and a job requiring sixteen distributed nodes (a job E) have occurred from a user to the control node 500.

### Step 1: Acceptance of Job and Estimation Of Resources

When the new jobs D and E as described above are given to the control node, the control node 500 performs estimation of the quantity of computational resources required for the new jobs by the computational resource quantity estimation unit 501 first. It is assumed that, as a result of the estimation, for example, an estimation result is obtained that the job D requires two times the computational resources of the job B, and the job E requires eight times the computational resources of the job B.

### Step 2: Grasping of Connection Situation

The control node 500 has database information that includes computational resource information including computational power of each of wide-range nodes to which the control node 500 is connected, arithmetic resource information including computational power of each arithmetic device, and a communication bandwidth between devices in each distributed node or between distributed nodes, position information about the distributed nodes and the like. The control node 500 searches for available computational resources from such database information. In the present embodiment, the control node 500 could grasp that computational resources of the area ₄, the area D and the areas (i) to (iv) are available.

### Step 3: Computation of Optimal Path

Next, based on the results obtained at steps 1 and 2, the control node 500 determines necessary distributed nodes based on the quantity of computational resources required for the jobs D and E and selects connection paths among the distributed nodes by the distributed node determination unit 502 and the path selection unit 503. In the present embodiment, it is assumed, for simplification, that performances of the distributed nodes are the same, and that an estimation result has been obtained that the jobs D and E require eight distributed nodes and sixteen distributed nodes, respectively. Based on the estimation result, all the distributed nodes of the areas 4 and D are selected for the job D to assure eight distributed nodes, and a path is selected which constitutes an 8-node distribution system where the distributed nodes are connected in a ring shape. Similarly, for the job E, sixteen distributed nodes of the areas (i) to (iv) are selected, and a path to constitute a distributed system is selected by connecting the sixteen distributed nodes in a ring shape.

### Step 4: Transmission of Path

After the determination of the path at step 3, the path setting unit of the control node provides setting information about the path to the distributed system of each area via the network or the like.

### Step 5: Switching of Path

In each distributed system, switching of a path is performed based on connection path information provided from the control node 500. For example, in a distributed system 204 of the area 4, interconnectors mutually connected between a distributed node 240-3 and a distributed node 240-4 are switched to data paths of the nodes in a downward direction of the FIG. 5, as shown in FIG. 5. Similarly, in a distributed system of the area D, interconnectors through which a distributed node 140-1 and a distributed node 140-2 are mutually connected are switched to data paths in an upward direction of the FIG. 5. By the switchings, a distributed system composed of eight distributed nodes connected with the distributed system 204 of the area ₄ and the distributed system 104 of the area D can be formed. Similarly, for the job E, path switching is performed so that the sixteen distributed nodes of the areas (i) to (iv) are connected in a ring shape. Thus, it is possible to provide computational resources corresponding to the quantity of computational resources corresponding to a request by each job or user and provide a distributed processing system that is optimal for processing a new job.

### Step 6: For Avoidance Function

Further, as shown in FIG. 6, when detecting a fault such as in a case where a distributed system of the area (ii) does not operate due to a disaster, or the like, the fault avoidance unit 505 of the control node 500 can perform switching of distributed systems so that processing is performed for the job E by a distributed system reduced with the areas (iii) and (iv). Here, it is also possible to, when the job D by the distributed processing systems of the areas 4 and D ends, perform control to revive the processing capacity by switching the operation by the two distributed systems of the areas (iii) and (iv) to operation by coupling four distributed systems including the distributed systems of the areas 4 and D.

Thus, according to the present embodiment, by distributed systems which are regionally separated and each of which includes power source equipment operating together as a distributed processing system, it is possible to provide a distributed processing system capable of, by utilizing distributed systems responding to space restrictions even in the case of a small- scale communication building with a limited space, flexibly and efficiently setting the scale of the distributed processing system while controlling power required for one distributed system in which a distributed node group is installed, and performing highly reliable and high-speed information processing.

In the embodiments of the present invention, even if a part of distributed systems or the whole one communication building is damaged due to a disaster, it is possible to flexibly set distributed systems constituting a distributed processing system by a control node that controls the distributed systems constituting the distributed processing system and the whole distribute processing system. Therefore, in the embodiments of the present invention, it is possible to provide a highly reliable distributed processing system capable of flexibly responding to a user's request in comparison with the form of a distributed processing system in which a power source and a distributed processing system are concentrated in one building.

In the embodiments of the present invention, the number of distributed nodes of each area is limited to four, and the number of transmission paths connecting areas is limited to two. However, the present invention is not limited to such a configuration but can also be applied to a more complicated distributed processing system. When the number of nodes and the number of transmission paths that can connect areas increase, the number of path patterns increases. Furthermore, processing performance varies according to the time of newly installing a distribute node, and data transfer speed on a transmission path between areas may vary depending on performance of hardware. Therefore, optimal path computation capable of maximizing information processing performance becomes complicated. In such a case, a computational engine specialized in combination computation, such as a quantum device, can be adopted for a path selection function.

In the embodiments described above, it is assumed that performances of distributed nodes are the same for simplification. However, there may be a case where characteristics of distributed nodes, interconnects transmission media and the like are different among distribution systems. For example, in the case of selecting a path that the bandwidth of a transmission medium is small, it is possible to respond to the case by providing a path selection circuit or the like with a function of compressing data. If compression can be performed between ½ and 1/10, it is possible to make a configuration so that degradation of information processing performance accompanying delay of data transfer time does not occur even under a condition that the bandwidth is limited to ½ to 1/10.

In the embodiments described above, a selection circuit that selects a path performs only path selection. However, by causing the selection circuit to have addition, subtraction and broadcasting functions required for collective communication, it is also possible to perform computations required for collective communication at the same time as selection of a path and improve information processing speed.

Further, by having a function of encrypting data to be handled, at the time of selecting a path, it becomes possible to securely move data at the time of moving the data to a distributed system installed in another area, and it is also possible to realize highly reliable information processing.

### INDUSTRIAL APPLICABILITY

Embodiments of the present invention are applicable to a distributed processing system capable of performing a large amount of information processing by mutually connecting small-scale information processing systems installed in small-scale communication buildings. Especially, embodiments of the present invention are applicable to a system that performs machine learning in neural networks, large-scale computation (such as large-scale matrix operation) or a large amount of data information processing.

### REFERENCE SIGNS LIST

101 to 103 Distributed system

110-1 to 110-4, 120-1 to 120-4, 130-1 to 130-4 Distributed node

111, 122, 133 Electric equipment

131 to 134 Transmission medium (optical fiber)

500 Control node.

1. (canceled)

7. A distributed processing system comprising:
a plurality of distributed systems;
transmission media connecting the plurality of distributed systems; and
a control node connected to the plurality of distributed systems, wherein:
each of the plurality of distributed systems comprises one or more distributed nodes constituting a distributed node group and a piece of electric equipment accommodating the distributed node group;
each of the plurality of distributed nodes comprises interconnects connected to the transmission media or another distributed node of the plurality of distributed nodes; and
the control node is configured to determine, based on a quantity of computational resources corresponding to a job to be executed in the distributed processing system, distributed systems and distributed nodes in the distributed systems to execute the job from among the plurality of distributed systems, select a connection path for data to be processed among the distributed systems, and provide information about an interconnect connection path for the distributed nodes of the distributed systems to execute the job.

8. The distributed processing system according to claim 7, wherein the control node comprises:
an estimation circuit configured to estimate the quantity of computational resources corresponding to the job to be executed by the distributed processing system;
a determination circuit configured to determine the distributed systems and the distributed nodes in the distributed systems to execute the job from among the plurality of distributed systems based on the estimated quantity of computational resources;
a selection circuit configured to select the connection path for the data to be processed among the distributed systems; and
a provision circuit configured to provide the information about the interconnect connection path for the distributed nodes of the distributed systems to execute the job.

9. The distributed processing system according to claim 7, wherein:
each of the distributed nodes comprises a selection circuit configured to select a path for the data based on the information about the connection path for the data; and
the selection circuit is further configured to select an interconnect to transmit the data to be processed, based on the information about the interconnect connection path.

10. The distributed processing system according to claim 9, wherein:
the information about the interconnect connection path is information about a path factor given to the data; and
the selection circuit is configured to give the path factor to the data input and select the interconnect to transmit the data to be processed based on the path factor.

11. The distributed processing system according to claim 9, wherein
in addition to the selection of the interconnect, the selection circuit is further configured to execute addition, subtraction, broadcasting, compression, or encryption of the data.

12. The distributed processing system according to claim ₇, wherein
in response to an abnormality occurring in at least one of the distributed systems executing the job, the control node is configured to determine distributed systems to execute the job and a connection path for the data to be processed among the distributed systems again.

13. A method of operating a distributed processing system, the distributed processing system comprising:
a plurality of distributed systems, wherein each of the plurality of distributed systems comprises one or more distributed nodes constituting a distributed node group;
transmission media connecting the plurality of distributed systems; and
a control node connected to the plurality of distributed systems, wherein the method comprises:
determining, by a control node, based on a quantity of computational resources corresponding to a job to be executed in the distributed processing system, distributed systems and distributed nodes in the distributed systems to execute the job from among the plurality of distributed systems;
selecting, by the control node, a connection path for data to be processed among the distributed systems; and
providing, by the control node, information about an interconnect connection path for the distributed nodes of the distributed systems to execute the job.

14. The method according to claim 13, wherein method further comprises:
estimating, by the control node, the quantity of computational resources corresponding to the job to be executed by the distributed processing system;
determining, by the control node, the distributed systems and the distributed nodes in the distributed systems to execute the job from among the plurality of distributed systems based on the estimated quantity of computational resources;
selecting, by the control node, the connection path for the data to be processed among the distributed systems; and
providing, by the control node, the information about the interconnect connection path for the distributed nodes of the distributed systems to execute the job.
